(19) United States
(12) Patent Application Publication
(10) Pub. No.: US 2021/0381444 A1
(43) Pub. Date: Dec. 9, 2021

(54) ELECTRONICALLY CONTROLLED THROTTLE DEVICE

(71) Applicant: Hitachi Automotive Systems, Ltd., Hitachinaka-shi, Ibaraki (JP)

(72) Inventors: Hidefumi HATSUZAWA, Hitachinaka-shi (JP); Takuya TANAKA, Hitachinaka-shi (JP); Toyoshi NEMOTO, Hitachinaka-shi (JP)

(73) Assignee: Hitachi Automotive Systems, Ltd., Hitachinaka-shi, Ibaraki (JP)

(21) Appl. No.: 17/260,001

(22) PCT Filed: Jul. 3, 2019
(86) PCT No.: PCT/JP2019/026411

§ 371 Date: Jan. 13, 2021

(30) Foreign Application Priority Data
Jul. 23, 2018 (JP) 2018-137513

(51) Int. Cl. F02D 9/10; H02K 5/10; H02K 5/22; H02K 7/116

(52) U.S. Cl. CPC F02D 9/1065; H02K 7/116; H02K 5/225; H02K 5/10

(57) ABSTRACT

An object of the present invention is to provide an electronically controlled throttle device having a structure in which a resin cover is separated into a cover body portion and a connector portion, and has improved watertightness without increasing the size of the device. The electronically controlled throttle device of the present invention includes a motor 2, a throttle valve 4, a chassis 1, a resin cover 12, and a circuit board 104. The resin cover 12 has a first cover portion 12-1, a second cover portion 12-2, and a conductive wire 22 provided at a connection portion between the first cover portion 12-1 and the second cover portion 12-2. The connection portion is joined by forming a molten portion 23 around the conductive wire 22.

### TECHNICAL FIELD

The present invention relates to an electronically controlled throttle device including a throttle valve that adjusts intake air of a gasoline engine or a diesel engine and a drive device thereof.

### BACKGROUND ART

As a background technology in this technical field, a throttle valve control device described in JP 2007-10514 A (PTL 1) is known. In the throttle valve control device of PTL 1 (Hereinafter referred to as an electronically controlled throttle device), a resin cover molded of a resin material is fixed to a throttle body with four screws sandwiching a seal member (Paragraph 0072). The resin cover has an integrally resin molded connector (Paragraph 0074).

### CITATION LIST

### Patent Literature

PTL 1: JP 2007-10514 A

### SUMMARY OF INVENTION

### Technical Problem

The resin cover of PTL 1 has an integrally resin molded connector.

Connectors of electronically controlled throttle devices vary in terms of the position on the resin cover and the insertion direction of the plug (external connector) depending on the customer and the model. For this reason, it has been difficult to share the resin cover among models having different positions of connectors and different insertion directions of plugs. It is necessary to create a resin mold for each model having a different position of the connector and a different insertion direction of the plug, which has led to an increase in cost.

In view of the above problem, there is conceivable a method of separating the resin cover into a connector portion and the other cover body portion, sharing the cover body portion, and changing the connector portion depending on the customer and the model. However, in this case, a structure in which the cover body portion and the connector portion are coupled by a screw, a rivet, or the like is required, and the electronically controlled throttle device is increased in size.

A motor is provided in the resin cover as a drive source for the throttle valve. When moisture enters the resin cover due to cleaning of the engine room or the like, the motor will break down and become inoperable. Therefore, when the resin cover is separated into the cover body portion and the connector portion, it is necessary to maintain the watertightness of these joint portions.

However, in the conventional assembly structure using a screw, a rivet, or the like, it is necessary to use an O-ring or the like in order to secure watertightness, and the electronically controlled throttle device is further increased in size.

An object of the present invention is to provide an electronically controlled throttle device having a structure in which a resin cover is separated into a cover body portion and a connector portion, and has improved watertightness without increasing the size of the device.

### Solution to Problem

In order to achieve the above object, an electronically controlled throttle device of the present invention has a structure in which a resin cover is separated into a first cover portion (cover body portion) and a second cover portion (connector portion), a conductive wire is provided at a connection portion between the first cover portion and the second cover portion, and the connection portion between the first cover portion and the second cover portion is welded by energizing the conductive wire.

### Advantageous Effects of Invention

According to the present invention, watertightness can be improved without increasing the size of the device. Problems, configurations, and effects other than those described above will be made clear by the following description of the embodiments.

### BRIEF DESCRIPTION OF DRAWINGS

FIG. 1 is a cross-sectional view of an electronically controlled throttle device to which the present invention is applied.

FIG. 2 is an exploded perspective view of a resin cover of the electronically controlled throttle device to which the present invention is applied.

FIG. 3 is an external perspective view of the electronically controlled throttle device to which the present invention is applied.

FIG. 4 is a perspective view of the electronically controlled throttle device to which the present invention is applied, with the resin cover removed.

FIG. 5 is an exploded three-dimensional view of the electronically controlled throttle device to which the present invention is applied.

FIG. 6 is a plan view of a gear housing chamber of the electronically controlled throttle device to which the present invention is applied.

FIG. 7 is a perspective view showing a main portion of a non-contact rotation angle detection device used in the electronically controlled throttle device to which the present invention is applied.

FIG. 8 is a cross-sectional view of the electronically controlled throttle device to which the present invention is applied.

FIG. 9 is a plan view of a gear housing chamber of the electronically controlled throttle device to which the present invention is applied.

FIG. 10 is an exploded perspective view showing an appearance of a resin cover according to an embodiment of the present invention.

FIG. 11 is a plan view of the resin cover as viewed from an arrow XI direction of FIG. 10.

FIG. 12 is a plan view of the resin cover as viewed from an arrow XII direction of FIG. 11.

FIG. 13 is a plan view of the electronically controlled throttle device as viewed from the resin cover side.

FIG. 14 is a plan view of the resin cover as viewed from the arrow XII direction of FIG. 11.

### DESCRIPTION OF EMBODIMENTS

A configuration of a motor-driven throttle valve control device (electronically controlled throttle device) to be mounted on an engine of a vehicle is hereinafter described. In an embodiment and a reference example of the present invention, the electronically controlled throttle device that is described is for use in a diesel engine, but it is also applicable to a gasoline engine by changing a part of configuration or operation that are not related to the invention.

### Reference Example

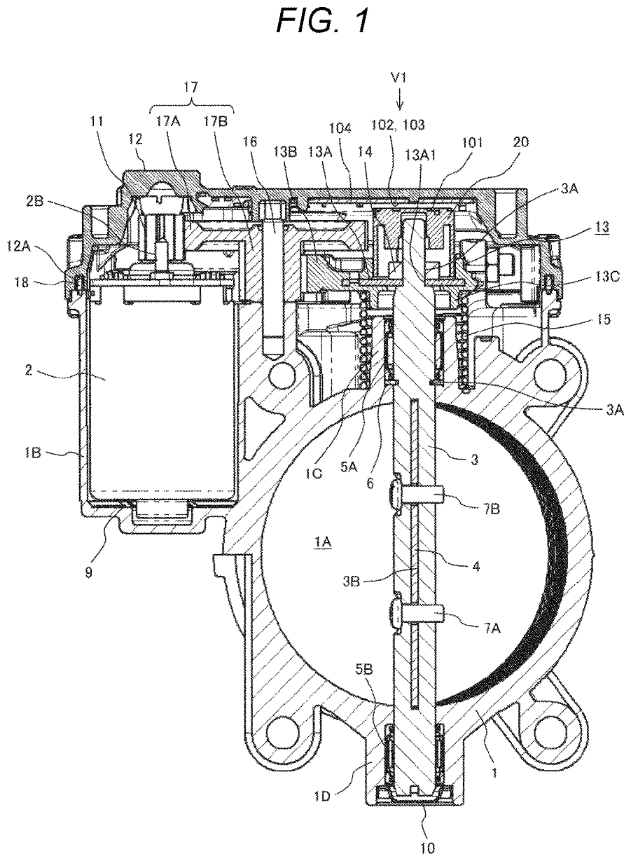

With reference to FIGS. 1 to 7, the electronically controlled throttle device to which the present invention is applied will be described below as a reference example. The following configuration described in the reference example is common to the electronically controlled throttle device according to an embodiment of the present invention, and the electronically controlled throttle device according to an embodiment of the present invention has the same configuration. Therefore, between the electronically controlled throttle device according to the reference example and the electronically controlled throttle device according to an embodiment of the present invention to be described later, the same components are given the same reference numerals, and the common description is omitted.

FIG. 1 is a cross-sectional view of the electronically controlled throttle device to which the present invention is applied.

In a throttle body 1 made of aluminum die cast, an intake passage (air passage) 1A and a motor housing 1B that houses a motor 2 are integrally molded. The throttle body 1 constitutes a chassis that houses the motor 2 and a throttle valve 4 that adjusts an air amount. That is, the throttle body (chassis) 1 has the air passage 1A, and the throttle valve 4 is held in the air passage 1A.

In the throttle body 1, a metal rotary shaft 3 is disposed along one diameter line of the intake passage LA. The rotary shaft 3 is a shaft member that supports the throttle valve 4, and will be hereinafter referred to as a throttle shaft. Both ends of the throttle shaft 3 are rotatably supported by needle bearings 5A and 5B. The needle bearings 5A and 5B are press-fitted and fixed to bearing boss portions 1C and 1D provided on the throttle body 1. After inserting a C-type washer 6 into a slit portion 3A provided on the throttle shaft 3, the needle bearing 5A is press-fitted, thereby regulating an axially movable amount of the throttle shaft 3. The C-type washer 6 will be hereinafter referred to as a thrust retainer.

The throttle shaft 3 is rotatably supported with respect to the throttle body 1. The throttle valve 4 including a disk made of a metal material is inserted into a slit 3B provided in the throttle shaft 3, and is fixed to the throttle shaft 3 by screws 7A and 7B.

When the throttle shaft 3 rotates, the throttle valve 4 rotates, and as a result, the cross-sectional area of the intake passage 1A changes to control the intake air flow rate to the engine.

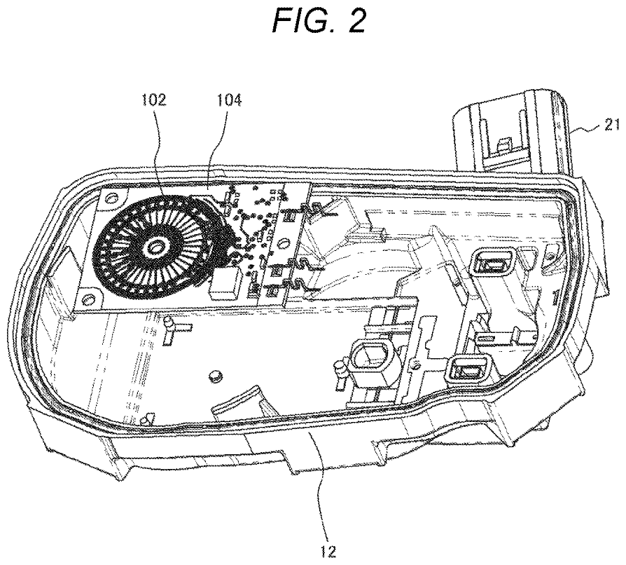

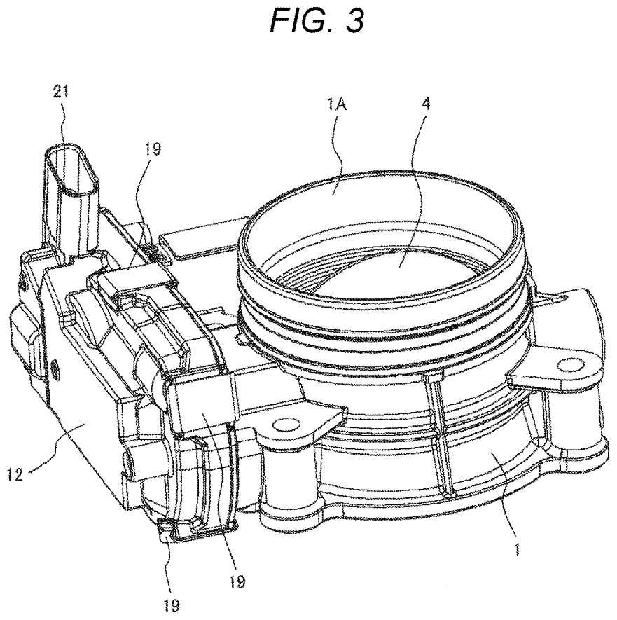

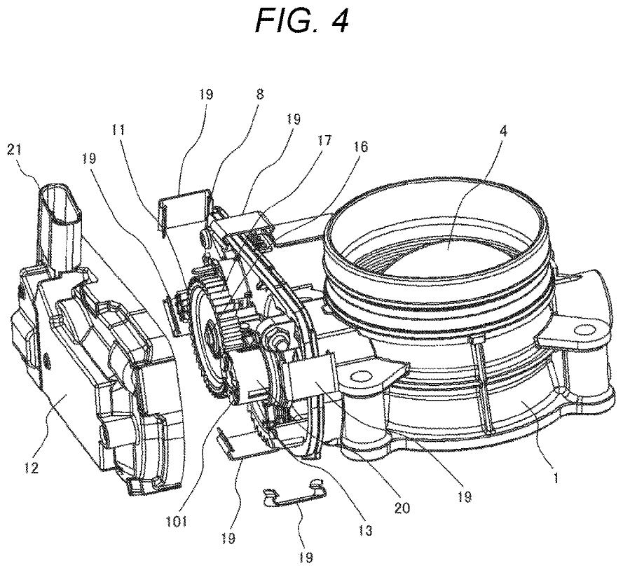

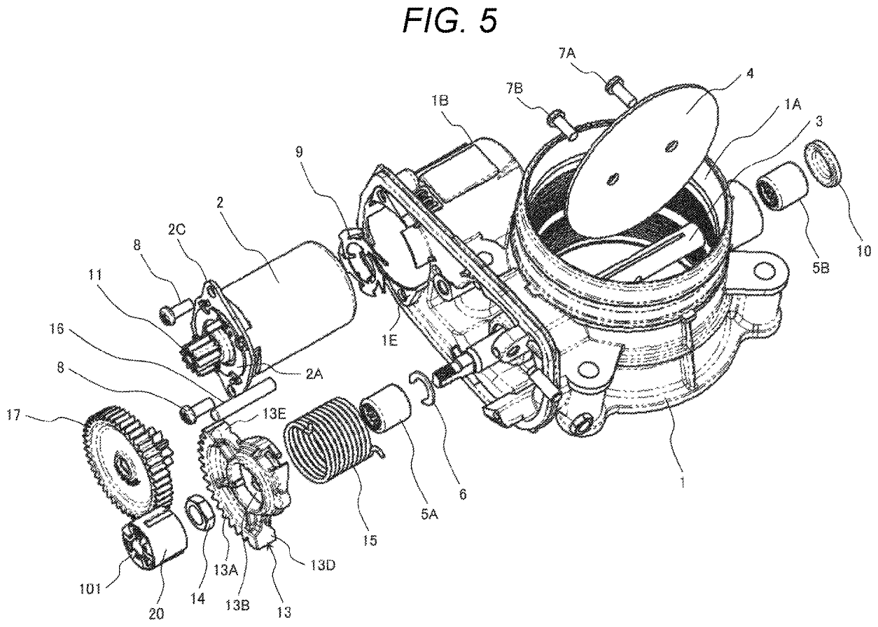

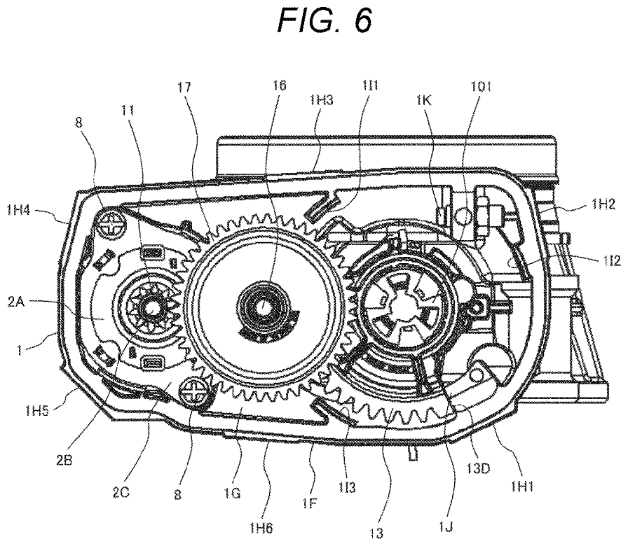

Next, description will be made with reference to FIGS. 2 to 6 together with FIG. 1. FIG. 2 is an exploded perspective view of the resin cover of the electronically controlled throttle device to which the present invention is applied. FIG. 3 is an external perspective view of the electronically controlled throttle device to which the present invention is applied. FIG. 4 is a perspective view of the electronically controlled throttle device to which the present invention is applied, with the resin cover removed. FIG. 5 is an exploded three-dimensional view of the electronically controlled throttle device to which the present invention is applied. FIG. 6 is a plan view of a gear housing chamber of an electronically controlled throttle device to which the present invention is applied. FIG. 2 shows the resin cover in a state of being viewed from the back side (inside). FIG. 6 is a view in which a resin cover 12 is removed and the throttle body 1 is viewed from a direction indicated by an arrow VI in FIG. 1.

The motor housing 1B is formed so as to be in parallel with the throttle shaft 3. In the present embodiment, the motor 2 includes a brush-type direct-current motor. As shown in FIG. 5, the motor 2 is inserted into the motor housing 1B so that an output shaft (rotary shaft) 2B of the motor 2 is parallel with the axial direction of the throttle shaft 3, and the motor 2 is fixed to a side wall 1E of the throttle body 1 by screwing a flange portion 2C of a bracket 2A of the motor 2 with a screw 8. A wave washer 9 is disposed at the end portion of the motor 2. The wave washer 9 supports the motor 2 in a direction along the axial direction of the output shaft 2B of the motor 2.

As shown in FIG. 1, openings of the bearing boss portions 1C and 1D are sealed with the needle bearings 5A and 5B to configure a shaft seal portion and maintain airtightness. The end portion of the bearing boss 1D side is sealed with a cap 10 to prevent the end portion of the throttle shaft 3 and the needle bearing 5B from being exposed to the outside.

This prevents air from leaking from the bearing portion, or prevents grease for lubrication of the bearing from leaking into the outside air or into a sensor chamber described later.

A metal gear 11 having the smallest number of teeth is fixed to an end portion of the rotary shaft 2B of the motor 2. A reduction gear mechanism and a spring mechanism for rotationally driving the throttle shaft 3 are collectively disposed on the side surface portion of the throttle body 1 on the side where the gear 11 is provided. Then, these mechanism portions are covered with the cover 12 made of a resin material fixed to the side surface portion of the throttle body 1. The cover 12 is connected to a throttle body (chassis) 1. Hereinafter, the cover 12 is sometimes referred to as a gear cover or a resin cover.

A so-called gear housing chamber covered with the resin cover 12 is provided with an inductance-type non-contact rotation angle detection device described later, and the rotation angle of the throttle shaft 3, and consequently the opening of the throttle valve 4, is detected. Since the non-contact rotation angle detection device constitutes a throttle sensor, the non-contact rotation angle detection device may be referred to as a throttle sensor.

A throttle gear 13 is fixed to an end portion of the throttle shaft 3 on the resin cover 12 side. The throttle gear 13 includes a metal plate 13A and a gear portion 13B made of a resin material resin molded to the metal plate 13A. The gear portion 13B made of a resin material is molded on the metal plate 13A by resin molding.

The metal plate 13A has a hole 13A1 in the center. A screw groove 3A is engraved around the tip portion of the throttle shaft 3. The tip of the throttle shaft 3 is inserted into the hole 13A1 of the metal plate 13A, and a nut 14 is screwed to a screw portion 3A, thereby fixing the metal plate 13A to the throttle shaft 3.

Thus, the metal plate 13A and the gear portion 13B made of a resin material formed thereon rotate integrally with the throttle shaft 3.

A return spring 15 formed of a helical spring is sandwiched between the back surface of the throttle gear 13 and the side surface of the throttle body 1.

A part of the return spring 15 in the axial direction of the throttle shaft 3 surrounds the bearing boss 1C, and one end portion thereof is locked to a notch (not shown) formed in the throttle body 1. This one end portion is configured so as not to be rotatable in the rotation direction of the throttle shaft 3. The other end portion side of the return spring 15 surrounds a cup-shaped portion 13C formed in the throttle gear 13, and the other end portion of the return spring 15 is locked in a hole (not shown) formed in the metal plate 13A. The other end portion of the return spring 15 is also configured so as not to be rotatable in the rotation direction of the throttle shaft 3.

Since this example relates to an electronically controlled throttle device of a diesel engine, the initial position of the throttle valve 4, i.e., the opening position at which the throttle valve 4 is provided as the initial position when the power source of the motor 2 is shut off, is a fully opened position. Therefore, the return spring 15 is preloaded in the rotation direction so that the throttle valve 4 maintains the fully opened position when the motor 2 is not energized.

Between the gear 11 attached to the rotary shaft 2B of the motor 2 and the throttle gear 13 fixed to the throttle shaft 3, an intermediate gear 17 rotatably supported by a shaft (intermediate shaft) 16 made of a metal material press-fitted and fixed to a side surface of the throttle body 1 is engaged. The intermediate gear 17 includes a large-diameter gear 17A engaged with the gear 11 and a small-diameter gear 17B engaged with the gear portion 13B made of a resin material of the throttle gear 13. Both of the gears 17A and 17B are integrally molded by resin molding. These gears 11, 17A, 17B, and 13B constitute a two-stage reduction gear mechanism. The rotation of the motor 2 is transmitted to the throttle shaft 3 via this reduction gear mechanism.

The motor 2 is a drive source for adjusting the opening of the throttle valve 4, and the motor 2 and the above-described reduction gear mechanism constitute a drive mechanism (drive device) of the throttle valve 4. The motor 2 adjusts the opening of the throttle valve 4 by rotating the throttle shaft 3 that holds the throttle valve 4 via the reduction gear mechanism described above.

The speed reduction mechanism and the spring mechanism are covered with the resin cover 12 made of a resin material. A groove 12A into which a seal member 18 is inserted is formed in an opening end side peripheral edge of the resin cover 12, and when the resin cover 12 covers a throttle body 6 with the seal member 18 being fitted into the groove 12A, the seal member 18 comes to close contact with an end surface of a frame around the gear housing chamber formed on the side surface of the throttle body 1 to shield the inside of the gear housing chamber from outside air, thereby ensuring watertightness and airtightness. In this state, the resin cover 12 is fixed to the throttle body 1 with six clips 19 (see FIG. 4).

That is, the throttle body 1, together with the resin cover 12, forms a gear housing space 1G that holds the motor 2 and a gear train (reduction gear mechanism having the gears 11, 17A, 17B, and 13B).

A rotation angle detection device, i.e., a throttle sensor, formed between the reduction gear mechanism configured as described above and the gear cover 12 covering the reduction gear mechanism will be specifically described.

At the end portion of the throttle shaft 3 on the resin cover 12 side, a resin holder 20 is fixed by welding. Therefore, when the motor 2 rotates and the throttle valve 4 rotates, an excitation conductor 101 also rotates integrally with the throttle valve 4.

As shown in FIGS. 1 and 4 to 6, the excitation conductor (conductor) 101 formed by press working is attached by integral molding on a plain surface of the tip end (end portion of the resin cover 12) of the resin holder 20. That is, simultaneously with the joining of the excitation conductor 101, the resin holder 20 is molded integrally with the excitation conductor 101. Thus, the excitation conductor 101 is held by the resin holder 20 in a state of being fixed by the resin material forming the resin holder 20. Thus, the assembly step of assembling the excitation conductor 101 to the resin holder 20 becomes unnecessary, productivity is improved, and the reliability of joining between the excitation conductor 101 and the resin holder 20 can be improved.

The excitation conductor 101 may be formed on the resin holder 20 by printing. Thus, productivity and reliability are improved for the same reason as described above, and the excitation conductor 101 is made thinner and lighter. As a result, the weight of the resin holder 20 is reduced, and the reliability of the joint portion between the throttle shaft 3 and the resin holder 20 can be improved.

As shown in FIG. 1, on the resin cover 12, an excitation conductor 102 and a signal detection conductor 103 of a throttle sensor 100 are fixed at positions facing the excitation conductor 101.

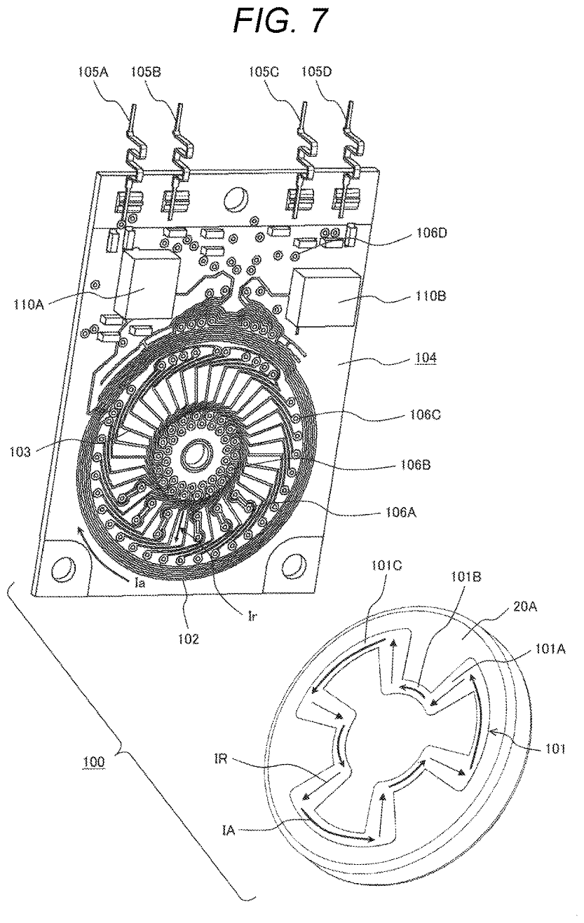

Here, in a case where the excitation conductor 101 has a structure of being electrically connected with the throttle shaft 3, when static electricity is applied to the connector terminal of the resin cover 12, a discharge occurs between the excitation conductor 101 and the excitation conductor 102 or between the excitation conductor 101 and the signal detection conductor 103, and microcomputers 110A and 110B (see FIG. 7) of the throttle sensor 100 may be broken.

Therefore, in this example, the excitation conductor 101 and the throttle shaft 3 are electrically insulated from each other by disposing the resin holder 20 between the excitation conductor 101 and the throttle shaft 3.

By forming the resin holder 20 by integral molding with the throttle shaft 3 and the excitation conductor 101, it is possible to provide a compact and inexpensive electronically controlled throttle body.

Here, after the throttle shaft 3 is assembled to the throttle body 6, the resin holder 20 is integrated with the throttle shaft 3, whereby the height of the excitation conductor 101 can be adjusted. Thus, a small clearance between the excitation conductor 101, the excitation conductor 102, and the signal detection conductor 103 can be accurately adjusted, and hence a highly accurate non-contact rotation angle detection device 100 can be obtained.

As shown in FIG. 6, the gear housing chamber 1G is partitioned by a frame 1F to which the resin cover 12 is fixed. Outside the frame 1F is provided with six attachment portions 1H1 to 1H6 for clipping the resin cover 12 with the clips 19 (see FIG. 3). 1H1 to 1H3 are walls for positioning the resin cover 12. When positioning projections of the resin cover 12 are locked to these three walls 1H1 to 1H3, the excitation conductor 102 and the signal detection conductor 102 are positioned with respect to the excitation conductor 101 on the rotation side, and a signal within a required allowable range can be output.

A fully opened stopper 1J mechanically determines the initial position (i.e., the fully opened position) of the throttle gear 13, and includes a projection integrally formed on the inner side wall of the throttle body 1. When a notch end portion 13D of the throttle gear 13 abuts on this projection 1J, the throttle shaft 3 cannot rotate beyond the fully opened position.

A fully closed stopper 1K regulates the fully closed position of the throttle shaft 3. An end 13E (see FIG. 5) on the opposite side of the throttle gear 13 collides with the fully closed stopper 1K in the fully closed position to prevent the throttle shaft 3 from rotating more than the fully closed position.

The fully opened stopper 1J and the fully closed stopper 1K determine the maximum value of the rotation range of the excitation conductor 101 fixed to the end portion of the throttle shaft 3.

When the throttle gear 13 is in the position of the stopper 1J, the output of the signal detection conductor 103 indicates the value of the full opening of the throttle valve 4. When the throttle gear 13 is in the position of the stopper 1K, the output of the signal detection conductor 103 indicates the value of the full close of the throttle valve 4.

In the present embodiment, the excitation conductor 101 is provided integrally with the resin holder 20 and the resin holder 20 is welded to the throttle shaft 3, whereby the configuration of these components can be simplified, the number of components can be reduced, and reliability can be improved. By adjusting the relative position relationship between the resin holder 20 and the throttle shaft 3, the distance between the excitation conductor 101 and the excitation conductor 102 and the signal detection conductor 103 can be accurately adjusted, and a predetermined sensor output can be accurately obtained.

In the present embodiment, since the resin holder 20 does not need to be resin molded using the throttle shaft 3 as an insert member, a large scale facility is not required. Therefore, it is possible to provide a highly productive, inexpensive non-contact inductance-type rotation detection device.

FIG. 7 is a perspective view showing a main portion of a non-contact rotation angle detection device used in the electronically controlled throttle device to which the present invention is applied.

As shown in FIG. 7, the excitation conductor 101 includes a linear portion 101A radially extending in the radial direction, an arcuate portion 101B provided so as to connect the inner peripheral sides of the linear portions 101A adjacent to each other, and an arcuate portion 101C provided so as to connect the outer peripheral sides of the linear portions 101A adjacent to each other. The linear portion 101A is disposed at six positions at intervals of 60 degrees from each other.

The resin cover 12 also serves as a case member of the throttle sensor (inductance-type rotation angle detection device) 100, and a fixed substrate 104 constituting a part of the throttle sensor 100 is fixed to the inner surface (back surface) of the resin cover 12 with an adhesive in a form of facing the excitation conductor 101. The fixed substrate 104 is a circuit board having a circuit related to detection of the opening of the throttle valve 4. After adhered to the resin cover 12 of the sensor, by applying a coating agent to the front surface and the back surface, the fixed substrate 104 is protected from abrasion powder and corrosive gas.

On the front side (side facing the excitation conductor 101) of the fixed substrate 104 serving as an insulating substrate, four annular excitation conductors 102 are printed. A plurality of radially extending signal detection conductors 103 is printed on the inside thereof. Also on the back side (side facing the excitation conductor 101) of the fixed substrate 104, the excitation conductor 102 and the signal detection conductor 103 similar to those on the front side are printed, and the excitation conductor 102 and the signal detection conductor 103 on the front and back sides are connected by through holes 106A to 106D.

In this example, a three-phase alternate-current signal that is out of phase by 120 degrees is obtained from the signal detection conductor 103.

Two sets of the same non-contact rotation detection devices are formed, and by comparing signals between of each other, it is possible to detect an abnormality in the sensor and to back up each other in the event of an abnormality.

Reference numerals 300L and 300M denote microcomputers, and each of them has a drive control and a signal processing function of the non-contact rotation angle detection device.

As shown in FIG. 7, terminals 105A to 105D are electrically connected to the fixed substrate 104. Of the terminals 105A to 105D, one functions as a power supply terminal (e.g., 105A), one functions as a ground terminal (e.g., 105C), and the remaining two terminals 105B and 105D function as signal output terminals of the respective rotation angle detection devices. y disposing the ground terminal between the signal terminals, it is possible to prevent both signals from being brought into an abnormal state at the same time due to a short circuit between the signal terminals.

The microcomputers 110A and 110B supply a current from the power supply terminal 105A to the excitation conductor 102, process three-phase alternate current waveforms generated in the signal detection conductor 103, detect the rotation position of the excitation conductor 101, and consequently detect the rotation angle of the throttle shaft 3.

Hereinafter, the operation of the non-contact, inductance-type rotation angle detection device of this example will be described.

It is conceivable that the microcomputer 110B basically controls conductor pattern groups 102 and 103 constituting the first rotation angle detection device formed on the front side of the fixed substrate 104. On the other hand, it is conceivable that the microcomputer 110A basically controls the conductor pattern groups 102 and 103 constituting the second rotation angle detection device formed on the back side of the fixed substrate 104. Each computer 110A and 110B supplies a direct current Ia from the power supply terminal 105A to the excitation conductor 102.

When the direct current Ia flows through the excitation conductor 102, a current IA in a direction opposite to the current Ia is excited in an outer peripheral arcuate conductor 101C of the excitation conductor 101 facing the excitation conductor 102. This excited current IA flows through the entire excitation conductor 101 in the direction of the arrow. The current IR flowing through the radial conductor 101A induces a current Ir in the radial conductor portion of the signal detection conductor 103 facing this part in a direction opposite to the current IR. This current Ir becomes an alternate current.

The 36 signal detection conductors 103 on the front, disposed at equal radial intervals, form three sets of phases (phases U, V, and W) patterns for the first rotation angle detection device, and the 36 signal detection conductors 103 on the back form three sets of phases (phases U, V, and W) patterns for the second rotation angle detection device.

When the excitation conductor 101 is at a specific rotation position, e.g., a start position (position where the rotation angle is zero), the alternate current Ir is an alternate current out of phase by 120 degrees in each of the phases U, V, and W.

When a disk portion 20A of the resin holder 20 provided with the excitation conductor 101 rotates, the phases of the alternate current of these three phases shift from one another. The microcomputers 110A and 110B detect the phase shift, and detect, from the phase shift, how much the excitation conductor 101 has rotated.

The two signal currents of the first and second rotation angle detection device signals to be input from the signal detection conductor 103 to the microcomputers 110A and 110B basically indicate the same value. The microcomputers 110A and 110B process the same signal current and output, from the signal terminals 105A to 105D, signal voltages having slopes opposite to each other and change amounts equal to each other. This signal is a signal proportional to the rotation angle of the disk portion 20A. The external device receiving this signal monitors both signals and determines whether the first and second rotation angle detection devices are normal. When either of them shows an abnormality, the signal of the remaining detection device is used as a control signal.

### First Embodiment

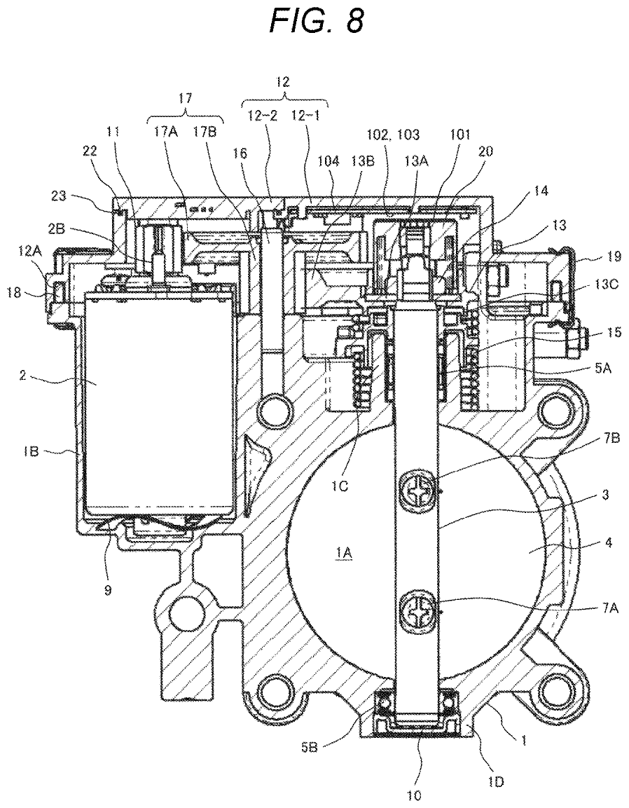

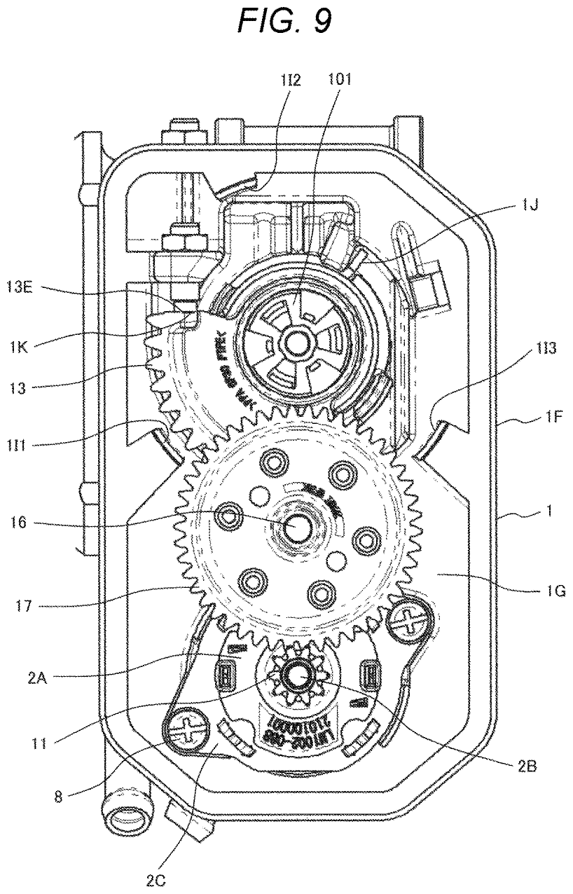

The electric throttle device of the present embodiment will be described with reference to FIGS. 8 and 9. FIG. 8 is a cross-sectional view of an electronically controlled throttle device to which the present invention is applied.

FIG. 9 is a plan view of a gear housing chamber of an electronically controlled throttle device to which the present invention is applied.

As the main difference from the reference example, the present embodiment has a configuration in which the resin cover 12 is separated into a cover body portion 12-1 and a connector portion 12-2. In the reference example, the bearing 5B that supports the throttle shaft 3 includes a needle bearing, but in the present embodiment, the bearing 5B includes a ball bearing. Regarding other configurations, the electric throttle device of the present embodiment has the similar configuration to the configuration described in the reference example.

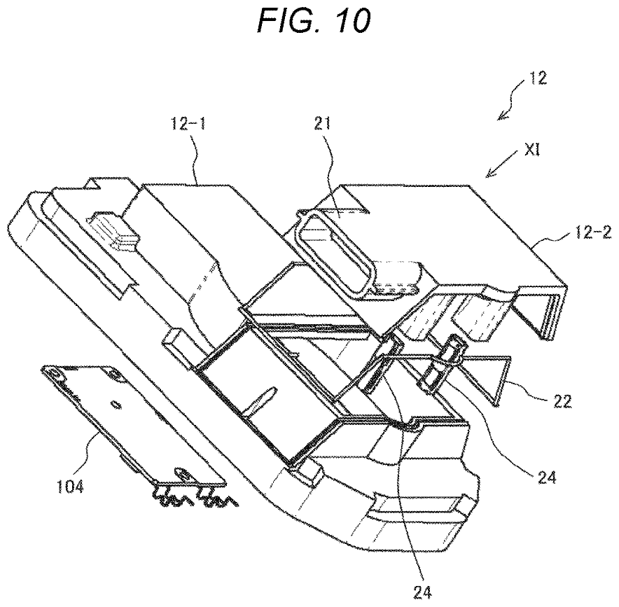

FIG. 10 is an exploded perspective view showing the appearance of a resin cover according to an embodiment of the present invention.

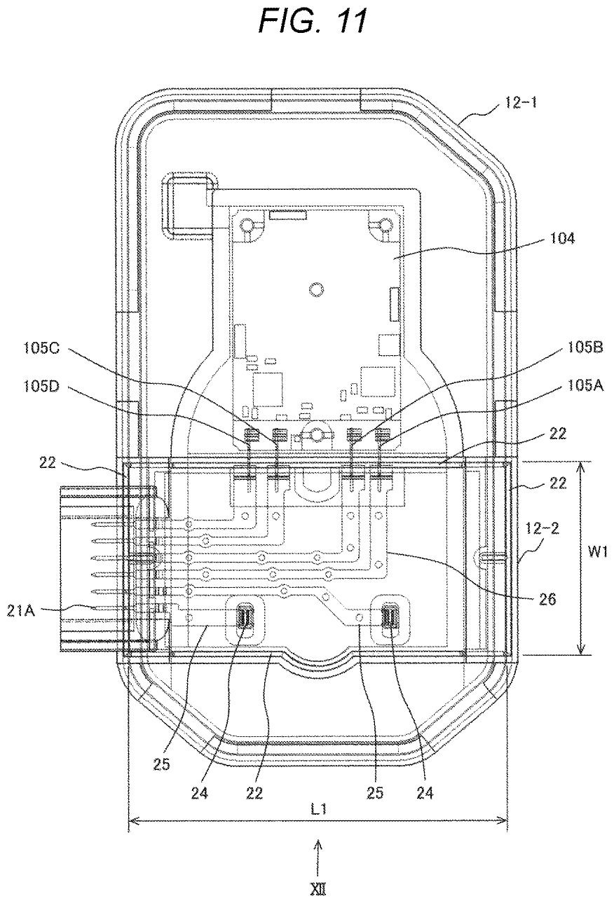

The resin cover 12 has an integrally resin molded connector 21. The connector 21 is an interface for electrically connecting the electronically controlled throttle device with an external device. For this purpose, the connector 21 has a terminal 21A (see FIG. 11) that mates with the other side (plug: external connector). The connector 21 of the electronically controlled throttle devices varies in terms of the position on the resin cover 12 and the insertion direction of the plug (external connector) depending on the customer and the model. For this reason, it has been difficult to share the resin cover 12 among models having different positions of the connector 21 and different insertion directions of the plug (models having different specifications). It is necessary to create a resin mold for each model having a different position of the connector 21 and a different insertion direction of the plug, which has led to an increase in cost. In the present embodiment, the sharing property of the resin cover 12 is improved among the models having different specifications.

Therefore, in the present embodiment, the resin cover 12 is separated into the cover body portion 12-1 and the connector portion 12-2.

However, when the resin cover 12 is divided into the cover body portion 12-1 and the connector portion 12-2 in order to improve the sharing property of the resin cover 12, it is necessary to ensure the watertightness and airtightness of the joint portion between the cover body portion 12-1 and the connector portion 12-2. In this case, in the structure where the connector portion 12-2 is assembled to the cover body portion 12-1 by a screw, a rivet, or the like, it is necessary to use an O-ring or the like in order to ensure the watertightness and airtightness, and there arises a problem that the size of the electronically controlled throttle device is increased.

In the present embodiment, as shown in FIG. 10, the resin cover 12 connected to the throttle body (chassis) 1 is divided into the first cover portion (cover body portion) 12-1 and the second cover portion (connector portion) 12-2. The connection portion between the first cover portion 12-1 and the second cover portion 12-2 is provided with a conductive wire 22. By energizing the conductive wire 22, the connection portion between the first cover portion 12-1 and the second cover portion 12-2 is welded, and the connection portion forms a molten portion 23 around the conductive wire 22 (see FIG. 8). The conductive wire 22 is energized after the conductive wire 22 is disposed at the connection portion between the first cover portion 12-1 and the second cover portion 12-2 and the second cover portion 12-2 is assembled to the first cover portion 12-1.

The first cover portion 12-1 supports the circuit board (fixed substrate) 104 having a circuit related to the opening detection of the throttle valve 4. The second cover portion 12-2 has the connector 21 electrically connected with an external connector, a motor connection terminal 24 electrically connected with the motor 2, a wiring conductor 25 that relays the motor connection terminal 24 and the connector 21, and a wiring conductor 26 that relays the circuit board 104 and the connector 21.

The wiring conductor 25 is a conductor that electrically connects the motor connection terminal 24 to the terminal 21A of the connector 21. The wiring conductor 26 is a conductor that electrically connects the terminals 105A to 105D of the circuit board 104 to the terminal 21A of the connector 21. The conductive wire 22 is a heating conductor for melting and coupling the first cover portion 12-1 and the second cover portion 12-2.

FIG. 11 is a plan view of the resin cover 12 as viewed from an arrow XI direction of FIG. 10. FIG. 11 shows the circuit board 104, the terminal 21A of the connector 21, the motor connection terminal 24, the wiring conductors 25 and 26, and the like in a transparent state.

The second cover portion 12-2 is provided with the wiring conductor 26 and the wiring conductor 25 in addition to the terminal 21A of the connector 21 and the motor connection terminal 24. The terminal 21A, the motor connection terminal 24, and the wiring conductors 25 and 26 are molded into the second cover portion 12-2.

In the present embodiment, the resin cover 12 of the electronically controlled throttle device is separated into the second cover portion 12-2 having the connector 21 and the other first cover portion 12-1, the first cover portion 12-1 is shared, and the second cover portion 12-2 is replaced in accordance with specifications designated by the customer and the model. This can improve the sharing property of the resin cover 12. It is further possible to improve the degree of freedom in disposition of the electronically controlled throttle device to the engine while suppressing the cost increase.

The connection portion between the first cover portion 12-1 and the second cover portion 12-2 is provided with the conductive wire 22, and the conductive wire 22 is energized to weld a joint portion 23, whereby an increase in size due to an additional component such as an O-ring can be avoided. The welded joint portion 23 can connect the first cover portion 12-1 and the second cover portion 12-2 while securing airtightness and watertightness. At this time, the insert components such as the terminal 21A of the connector 21, the motor connection terminal 24, and the wiring conductors 25 and 26 are all disposed on the second cover portion 12-2, whereby the cost required for the mold of the first cover portion 12-1 can be suppressed.

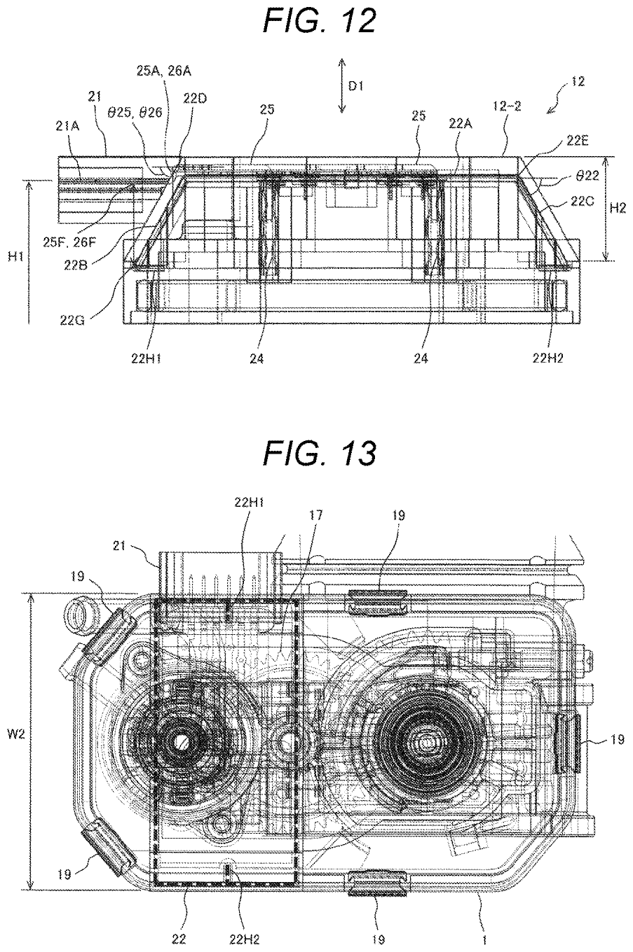

In the present embodiment, as shown in FIG. 11, when viewed from a direction along the thickness direction of the second cover portion 12-2, the motor connection terminal 24 and the wiring conductors 25 and 26 are disposed so as to overlap the region surrounded by the conductive wire 22. That is, when the motor connection terminal 24, the wiring conductors 25 and 26, and the conductive wire 22 are projected onto a plane perpendicular to a thickness direction D1 (see FIG. 12), the motor connection terminal 24 and the wiring conductors 25 and 26 are disposed in a region inside relative to the conductive wire 22, inside a region surrounded by the side of a length L1 and the side of a width W1 in FIG. 11. Therefore, the motor connection terminal 24 and the wiring conductors 25 and 26 do not overlap the conductive wire 22 in FIG. 11.

Since the wiring conductors 25 and 26 and the motor connection terminal 24 are disposed so as to overlap the space inside the conductive wire 22, it is possible for the wiring conductors 25 and 26 and the motor connection terminal 24 to avoid interference with the conductive wire 22, and possible to suppress the size of the thickness direction D1 of the electronically controlled throttle device. Thus, the size of the electronically controlled throttle device can be made compact.

FIG. 12 is a plan view of the resin cover as viewed from an arrow XII direction of FIG. 11. FIG. 12 shows the terminal 21A of the connector 21, the conductive wire 22, the motor connection terminal 24, the wiring conductors 25 and 26, and the like in a transparent state. Since FIG. 12 is a plan view, the resin cover 12, the terminal 21A of the connector 21, the conductive wire 22, the motor connection terminal 24, and the wiring conductors 25 and 26 are projected onto a plane parallel to the thickness direction D1.

The conductive wire 22 has a rectangular shape having a side of the length L1 and a side of the width W1 in FIG. 11. On the other hand, the conductive wire 22 has a horizontal portion 22A and inclined portions 22B and 22C in FIG. 12. That is, in the conductive wire 22, in FIG. 12, the end portion on the connector side at the side of the length L1 and the end portion on the opposite side are bent at a bend portion 22D and a bend portion 22E, respectively, and inclined toward the throttle body 1 side.

The wiring conductor 25 is disposed in parallel with the horizontal portion 22A of the conductive wire 22, is bent at a bend portion 25A toward the throttle body 1 side, and is further bent in the horizontal direction to form the terminal 21A of the connector 21. If the wiring conductor 25 is pulled out in the horizontal direction without providing the bend portion 25A, a height position H1 of the terminal 21A is increased, and accordingly, the connector 21 has to be increased, resulting in an increase in the height dimension of the electronically controlled throttle device. The wiring conductor 26 is also formed in the same shape as that of the wiring conductor 25.

In the present embodiment, when viewed from the direction along the thickness direction D1 of the second cover portion 12-2, the wiring conductors 25 and 26 or the terminal 21A has straddle portions 25F and 26F straddling the conductive wire 22. The straddle portions 25F and 26F come close to the throttle body 1 by bending the bend portions 25A and 26A in one direction (direction of coming close to the throttle body 1 in the present embodiment) of the thickness direction D1. The conductive wire 22 is bent in the one direction described above in the thickness direction D1 so that an overlap portion 22G overlapping the straddle portions 25F and 26F comes close to the throttle body 1.

Since the wiring conductors 25 and 26 and the conductive wire 22 are both bent in the same orientation (orientation of coming close to the throttle body 1), the wiring conductors 25 and 26 can come close to the throttle body 1 without interfering with the conductive wire 22. That is, the conductive wire 22 is bent at the bend portion 22D in an orientation of coming close to the throttle body 1, and hence the overlap portion 22G of the conductive wire 22 overlapping the straddle portions 25F and 26F avoids the wiring conductors 25 and 26 or the terminal 21A. This can suppress the size of the second cover portion 12-2 in the thickness direction, and can make the size of the electronically controlled throttle device compact.

The bend portion 22D of the conductive wire 22 is formed so that its bend angle θ22 is smaller than bend angles θ25 and θ26 of the bend portions 25A and 26A of the wiring conductors 25 and 26. In this case, the bend angle θ22 of the bend portion 22D of the conductive wire 22 is an angle smaller than 90°. Since the conductive wire 22 is bent not at a right angle but at an angle smaller than the right angle, when the second cover portion 12-2 is pressed against the first cover portion 12-1 in the thickness direction D1, a pressing load can be applied to the connection portion between the second cover portion 12-2 and the first cover portion 12-1. Thus, the connection portion between the second cover portion 12-2 and the first cover portion 12-1 is welded and joined without any gap, and airtightness and watertightness of the gear housing portion 1G can be secured.

FIG. 13 is a plan view of the electronically controlled throttle device as viewed from the resin cover 12 side. FIG. 13 shows the internal reduction gear mechanism in a transparent state. The conductive wire 22 is indicated by a broken line.

In the present embodiment, the first cover portion 12-1 and the throttle body (chassis) 1 are connected by a connection member 19. In this case, the connection member 19 is provided so as not to overlap the conductive wire 22 when viewed from a direction along the thickness direction D1 of the second cover portion 12-2. Since the connection member 19 is disposed avoiding the conductive wire 22, the edge of the second cover portion 12-2 can be brought close to the edge of the first cover portion 12-1. Thus, under the condition that a height dimension H2 (see FIG. 12) of the second cover portion 12-2 is identical, the bend angle θ22 of the conductive wire 22 can be made smaller. Therefore, it is not necessary to increase a dimension W2 of the resin cover 12 in order to make the angle θ22 smaller. Therefore, the dimension W2 of the resin cover 12 (see FIG. 13) can be reduced, and the electronically controlled throttle device can be compactly formed.

In the present embodiment, terminals (conductive wire terminal) 22H1 and 22H2 that connect the power supply when the conductive wire 22 is energized are protruded from the conductive wire 22 toward the inside of the second cover portion 12-2. Thus, under the condition that a height dimension H2 (see FIG. 12) of the second cover portion 12-2 is identical, the bend angle θ22 of the conductive wire 22 can be made smaller. Therefore, it is not necessary to increase a dimension W2 of the resin cover 12 in order to make the angle θ22 smaller. Therefore, the dimension W2 of the resin cover 12 (see FIG. 13) can be reduced, and the electronically controlled throttle device can be compactly formed.

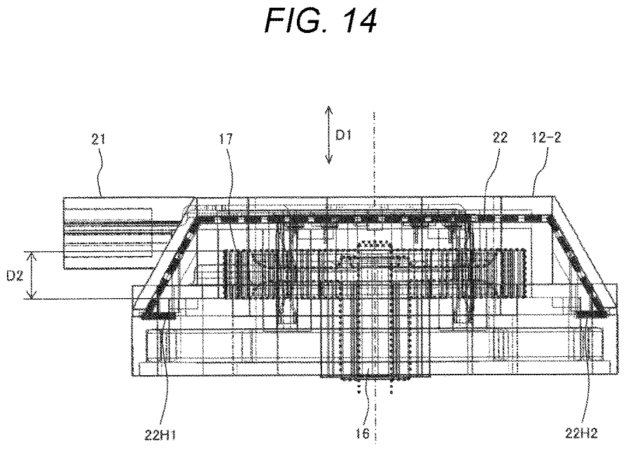

FIG. 14 is a plan view of the resin cover as viewed from the arrow XII direction of FIG. 11. FIG. 14 shows the inside of the resin cover in a transparent state, and indicates the intermediate gear 17 and its shaft 16 by a dotted line and the conductive wire 22 by a broken line. FIG. 14 is a plan view in which the intermediate gear 17, the shaft 16, the conductive wire 22, and the second cover portion 12-2 are projected onto a plane (virtual plane) parallel to the thickness direction D1 of the second cover portion 12-2. The thickness direction D1 is parallel to the axial direction of the shaft 16 of the intermediate gear 17.

In the plan view of FIG. 14, the intermediate gear 17 overlaps the conductive wire 22 in a range of D2 in the thickness direction D1 (axial direction of the intermediate shaft 17) of the second cover portion 12-2. This can prevent the dimension of the electric throttle device in the thickness direction D1 from increasing, and make the electric throttle device compact.

The conductive wire terminals 22H1 and 22H2 of the conductive wire 22 are provided so as to protrude from the connection portion between the first cover portion 12-1 and the second cover portion 12-2 so that the power source can be connected. As shown in FIG. 13, the conductive wire terminals 22H1 and 22H2 are disposed at positions that do not overlap the intermediate gear 17, when viewed from the axial direction of the intermediate shaft 17.

When the conductive wire terminals 22H1 and 22H2 and the intermediate gear 17 overlap, it is necessary to provide a gap between the conductive wire terminals 22H1 and 22H2 and the intermediate gear 17, and it is necessary to dispose the conductive wire terminals 22H1 and 22H2 at positions higher than the position of the intermediate gear 17. In this case, it is necessary to dispose the second cover portion 12-2 at a high position, which increases the size of the electric throttle device. However, in the present embodiment, it is possible to prevent the electric throttle device from becoming large in the thickness direction D1 (axial direction of the intermediate shaft 17), and to make the electric throttle device compact.

It should be noted that the present invention is not limited to the embodiment described above, and includes various modifications. For example, the embodiment described above has been described in detail for the purpose of explaining the present invention in an easy-to-understand manner, and is not necessarily limited to that having all configurations. Another configuration can be added to, deleted from, or replaced with a part of the configuration of the embodiment.

### REFERENCE SIGNS LIST

1 throttle body (chassis)
2 motor
3 throttle shaft
4 throttle valve
12 resin cover
12-1 cover body portion (first cover portion)
12-2 connector portion of resin cover 12 (second cover
portion)
16 intermediate shaft
17 intermediate gear
19 connection member
21 connector
22 conductive wire
22D bend portion of conductive wire 22
22H1, 22H2 conductive wire terminal
23 molten portion (joint portion)
24 motor connection terminal
25, 26 wiring conductor
25F, 26F straddle portion
25A, 26A bend portion of wiring conductor 25 or 26
104 fixed substrate (circuit board).

1. An electronically controlled throttle device, comprising:
a motor;
a throttle valve that adjusts an air amount;
a chassis that houses the motor and the throttle valve;
a resin cover connected to the chassis; and
a circuit board having a circuit related to opening detection of the throttle valve, wherein the resin cover has a first cover portion, a second cover portion, and a conductive wire provided at a connection portion between the first cover portion and the second cover portion,
the connection portion forms a molten portion around the conductive wire,
the first cover portion supports the circuit board, and
the second cover portion has a connector connected to an external connector, a motor connection terminal electrically connected to the motor, and a wiring conductor that relays the motor connection terminal and the connector.

2. The electronically controlled throttle device according to claim 1,
wherein when viewed from a direction along a thickness direction of the second cover portion,
the motor connection terminal and the wiring conductor overlap a region surrounded by the conductive wire.

3. The electronically controlled throttle device according to claim 2,
wherein when viewed from a direction along a thickness direction of the second cover portion,
the wiring conductor has a straddle portion straddling the conductive wire, and has a bend portion bent in one direction in the thickness direction so that the straddle portion comes close to the chassis, and
the conductive wire has a bend portion bent in one direction in the thickness direction so that an overlap portion overlapping the straddle portion comes close to the chassis.

4. The electronically controlled throttle device according to claim 3,
wherein a bend angle of the bend portion of the conductive wire is smaller than a bend angle of the bend portion of the wiring conductor.

5. The electronically controlled throttle device according to claim 1, comprising:
a connection member that connects the first cover portion and the chassis,
wherein when viewed from a direction along a thickness direction of the second cover portion,
the conductive wire is provided so as not to overlap the connection member.

6. The electronically controlled throttle device according to claim 3, comprising:
a throttle shaft to which the throttle valve is connected; and
an intermediate shaft and an intermediate gear that transmit torque generated by the motor to the throttle shaft,
wherein when the conductive wire and the intermediate gear are projected onto a virtual plane parallel to the intermediate shaft,
the intermediate gear overlaps the conductive wire in an axial direction of the intermediate shaft.

7. The electronically controlled throttle device according to claim 1, comprising:
a throttle shaft to which the throttle valve is connected; and
an intermediate shaft and an intermediate gear that transmit torque generated by the motor to the throttle shaft,
wherein the conductive wire has a conductive wire terminal protruding from the connection portion between the first cover portion and the second cover portion, and
when viewed from an axial direction of the intermediate shaft, the conductive wire terminal is disposed at a position not overlapping the intermediate gear.
